(19) United States
(12) Patent Application Publication
(10) Pub. No.: US 2017/0093833 A1
(43) Pub. Date: Mar. 30, 2017

(54) SYSTEM, METHOD, AND PROGRAM FOR SHARING SCREEN

(71) Applicant: OPTiM Corporation, Saga (JP)

(72) Inventor: Shunji SUGAYA, Tokyo (JP)

(21) Appl. No.: 14/982,343

(22) Filed: Dec. 29, 2015

(30) Foreign Application Priority Data
Sep. 30, 2015 (JP) 2015-192621

(51) Int. Cl. H04L 29/06; H04L 29/08

(52) U.S. Cl. CPC H04L 63/08; H04L 67/104

(57) ABSTRACT

The present invention is to maintain security, enable an easy network configuration and authentication, and enhance the user-friendliness in screen sharing. In the system for sharing a screen, including a terminal and a server, a source terminal includes a detection module 111 that detects whether or not a destination terminal is connected with the same network; and performs authentication if detecting that the destination terminal is connected with the same network, by running the authentication module 112. If the authentication succeeds, the source terminal directly connects to the destination terminal through P2P by running the direct connection module 113 and preforms screen sharing by running the sharing module 114.

### CROSS REFERENCE TO RELATED APPLICATIONS

This application claims priority to Japanese Patent Application No. 2015-192621 filed on Sep. 30, 2015, the entire contents of which are incorporated by reference herein.

### TECHNICAL FIELD

The present invention relates to a system, a method, and a problem for sharing a screen with a destination terminal.

### BACKGROUND ART

Recently, a public line network such as the Internet has allowed terminals to share a screen. In such a screen sharing, terminals sharing a screen transmit and receive shared screen data indirectly through a server or directly by a P2P network.

Patent Document 1 discloses the system that allows only specific terminals to transmit and receive shared screen data by permitting only specific IP addresses to access the server and then authenticating the users.

### CITATION LIST

### Patent Literature

Patent Document 1: JP 2001-256137 A

### SUMMARY OF INVENTION

However, when transmitted and received by a P2P network, shared screen data may be shared with unintended terminals. This may causes security risks.

Moreover, the system of Patent Document 1 improves the security by permitting only specific IP addresses to access the server and then authenticating the users. However, the system of Patent Document 1 is less convenient because requiring to previously register IP addresses or users which can transmit and receive shared screen data.

An objective of the present invention is to a system, a method, and a program for sharing a screen, which maintain security, enable an easy network configuration and authentication, and enhance the user-friendliness in screen sharing.

According to the first aspect of the present invention, a system for sharing a screen includes a terminal and a server, the system permitting the terminal connected with a same network to share a screen, in which

the terminal includes:
a detection unit that detects whether or not a destination terminal is connected with the same network;
an authentication unit that authenticates the destination terminal for screen sharing if the detection unit detects that the destination terminal is connected with the same network;
a direct connection unit that directly connects to the destination terminal if the authentication unit authenticates the destination terminal; and
a sharing unit that shares a screen with the destination terminal by the direct connection.

According to the first aspect of the present invention, a system for sharing a screen includes a terminal and a server, the system permitting the terminal connected with a same network to share a screen, the terminal detects whether or not a destination terminal is connected with the same network; authenticates the destination terminal for screen sharing if detecting that the destination terminal is connected with the same network; directly connects to the destination terminal if authenticating the destination terminal; and shares a screen with the destination terminal by the direct connection.

The first aspect of the present invention is the category of a terminal for sharing a screen, but the categories of a method and a program for sharing a screen have similar functions and effects.

According to a second aspect of the present invention, in the system according to the first aspect of the present invention, the terminal is connected with the server, the authentication unit authenticates the destination terminal for screen sharing by enquiring of the server about the authentication.

According to a second aspect of the present invention, in the system according to the first aspect of the present invention, the terminal authenticates the destination terminal for screen sharing by enquiring of the server about the authentication.

According to a third aspect of the present invention, in the system according to the first or the second aspect of the present invention,

the sharing unit serially transmits shared data to the destination terminal or serially receives shared data from the destination terminal.

According to a third aspect of the present invention, in the system according to the first or the second aspect of the present invention, the terminal serially transmits shared data to the destination terminal or serially receives shared data from the destination terminal.

According to the fourth aspect of the present invention, a method for sharing a screen includes the step of permitting the terminal connected with a same network to share a screen, in which

the terminal executes the steps of
detecting whether or not a destination terminal is connected with the same network;
authenticating the destination terminal for screen sharing if detecting that the destination terminal is connected with the same network;
directly connecting to the destination terminal if authenticating the destination terminal; and
sharing a screen with the destination terminal by the direct connection.

According to the fifth aspect of the present invention, a computer program product for use in a system for sharing a screen, including a terminal and a server, the system permitting the terminal connected with a same network to share a screen includes a non-transitory computer usable medium having a set of instructions physically embodied therein, the set of instructions including computer readable program code, which when executed by the system for sharing a screen causes the information processing unit to:

detect whether or not a destination terminal is connected with the same network;

authenticate the destination terminal for screen sharing if detecting that the destination terminal is connected with the same network;

directly connect to the destination terminal if authenticating the destination terminal; and

share a screen with the destination terminal by the direct connection.

The present invention can provide a system, a method, and a problem for sharing a screen, which maintain security, enable an easy network configuration and authentication, and enhance the user-friendliness in screen sharing.

### BRIEF DESCRIPTION OF DRAWINGS

FIG. 1 shows the overall view of a preferable embodiment of the present invention.

FIG. 2 is the functional block diagram of a terminal 100 and a server 200 to illustrate the relationship among the functions.

FIG. 3 is the flow chart of the screen sharing process when a destination terminal 100b displays a screen of a source terminal 100a.

FIG. 4 is the flow chart of the screen sharing process when a source terminal 100a displays a screen of a destination terminal 100b.

FIG. 5 shows an example of the destination selection screen displayed on the source terminal 100a.

FIG. 6 shows an example of the screen-sharing request screen displayed on the destination terminal 100b.

FIG. 7 shows another example of the destination selection screen displayed on the source terminal 100a.

FIG. 8 shows another example of the screen-sharing request screen displayed on the destination terminal 100b.

FIG. 9 shows an example of the screen displayed on the source terminal 100a if the destination terminal 100b has accepted a screen-sharing request.

FIG. 10 shows an example of the screen displayed on the source terminal 100a if the destination terminal 100b has rejected a screen-sharing request.

FIG. 11 is the flow chart of the authentication process executed by the terminal 100 and the server 200.

FIG. 12 shows an example of the destination input screen to specify a destination terminal.

FIG. 13 shows an example of the error screen if the specified destination terminal cannot be detected in the same network.

FIG. 14 shows an example of the input screen for the authentication of a user ID and a password, which is displayed on the terminal 100.

FIG. 15 shows an example of the dialog screen if the authentication succeeds.

FIG. 16 shows an example of the dialog screen if the authentication fails.

### DESCRIPTION OF EMBODIMENTS

Embodiments of the present invention will be described below with reference to the attached drawings. However, this is illustrative only, and the technological scope of the present invention is not limited thereto.

### Overview of System for Sharing Screen

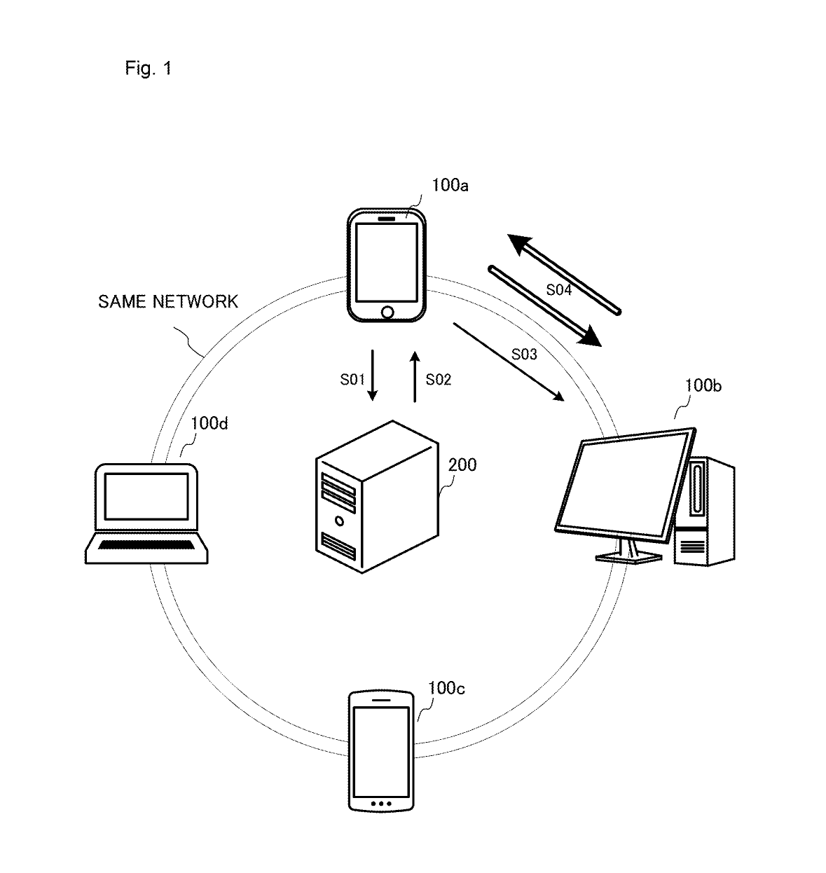

The outline of the present invention will be described below with reference to FIG. 1. The terminals 100a, 100b, 100c, and 100d are in a same network. Examples of the same network herein may include a local area network with which all terminals 100 are connected, a network with same wireless or wired network addresses, and a network with same service set identifiers (hereinafter referred to as “SSIDs”). The server 200 is connected with each of the terminals 100a, 100b, 100c, and 100d through a public line network. The terminal 100a judges whether or not the terminals 100b, 100c, and 100d are in the same network by acquiring the IP address and the subnet mask of each of the terminals 100b, 100c, and 100d. Furthermore, the terminal 100a can judge that a certain level of security is maintained by confirming that the terminals 100b, 100c, and 100d are in the same network.

The source terminal 100a transmits a screen-sharing request to a destination terminal 100b in the same network. The source terminal 100a detects whether or not the destination terminal 100b is in the same network. If the destination terminal 100b is in the same network, the source terminal 100a transmits an authentication request to the server 200 before performing screen sharing (step S01).

The server 200 receives the authentication request from the source terminal 100a and judges whether or not the source terminal 100a has already been authenticated. If having not authenticated the source terminal 100a yet, the server 200 exchanges data necessary for authentication with the source terminal 100a. If the source terminal 100a has already been authenticated, or after exchanging data with the source terminal 100a for authentication, the server 200 transmits the authentication result to the source terminal 100a (step S02).

If the server 200 has successfully authenticated the source terminal 100a, the source terminal 100a directly connects to the destination terminal 100b and transmits a screen-sharing request (step S03). If the server 200 has unsuccessfully authenticated the source terminal 100a, the source terminal 100a outputs authentication failure.

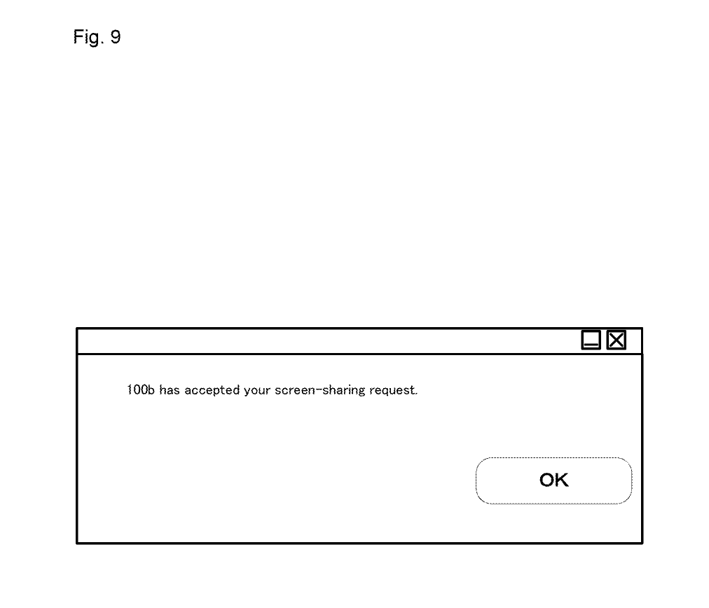

If the destination terminal 100b has accepted the screen-sharing request from the source terminal 100a, the source terminal 100a transmits and receives shared screen data to and from the destination terminal 100b through direct connection to share a screen with the destination terminal 100b (step S04). In this case, the source terminal 100a may output that the destination terminal 100b has accepted the screen-sharing request. FIG. 9 is an example of the screen displayed on the source terminal 100a if the destination terminal 100b accepts a screen-sharing request.

In the step S04, if the destination terminal 100b displays a screen of the source terminal 100a, the source terminal 100a transmits shared screen data to the destination terminal 100b. If displaying a screen of the destination terminal 100b, the source terminal 100a receives shared screen data from the destination terminal 100b.

Which screen of the source terminal 100a or the destination terminal 100b is shared may be set on a screen-sharing request or after screen sharing starts. Moreover, the shared screen may be switched between those of the source terminal 100a and the destination terminal 100b during screen sharing.

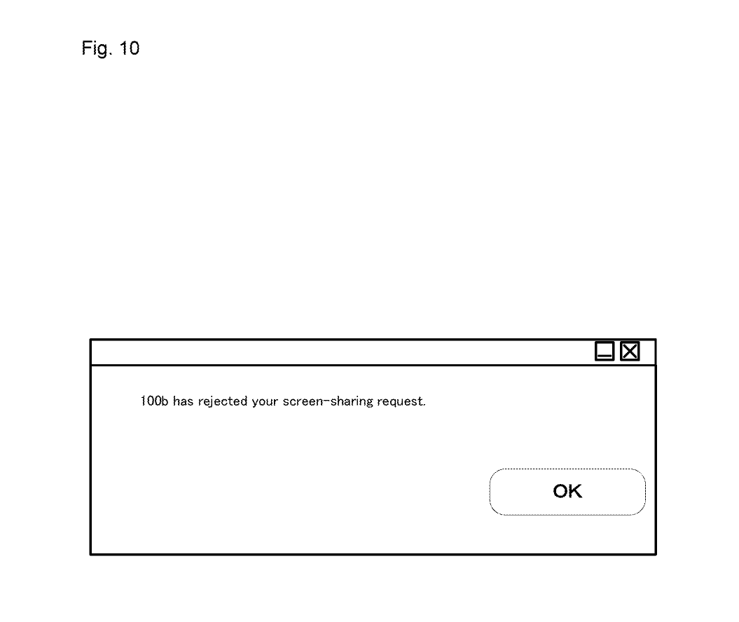

If the destination terminal 100b has rejected the screen-sharing request from the source terminal 100a, the source terminal 100a may output authentication failure. FIG. 10 is an example of the screen displayed on the source terminal 100a if the destination terminal 100b has rejected a screen-sharing request.

In this example, two terminals, which are the source terminal 100a and the destination terminal 100b, share a screen among themselves. However, more than two terminals may share a screen each other. In this case, the source terminal 100a connects to the destination terminal 100c so that the destination terminals 100b and 100c may display a screen of the source terminal 100a. Alternatively, the source terminal 100a may display the screens of both the destination terminals 100b and 100c. In this case, the source terminal 100a directly connects to each of the destination terminals 100b and 100c.

### Functions

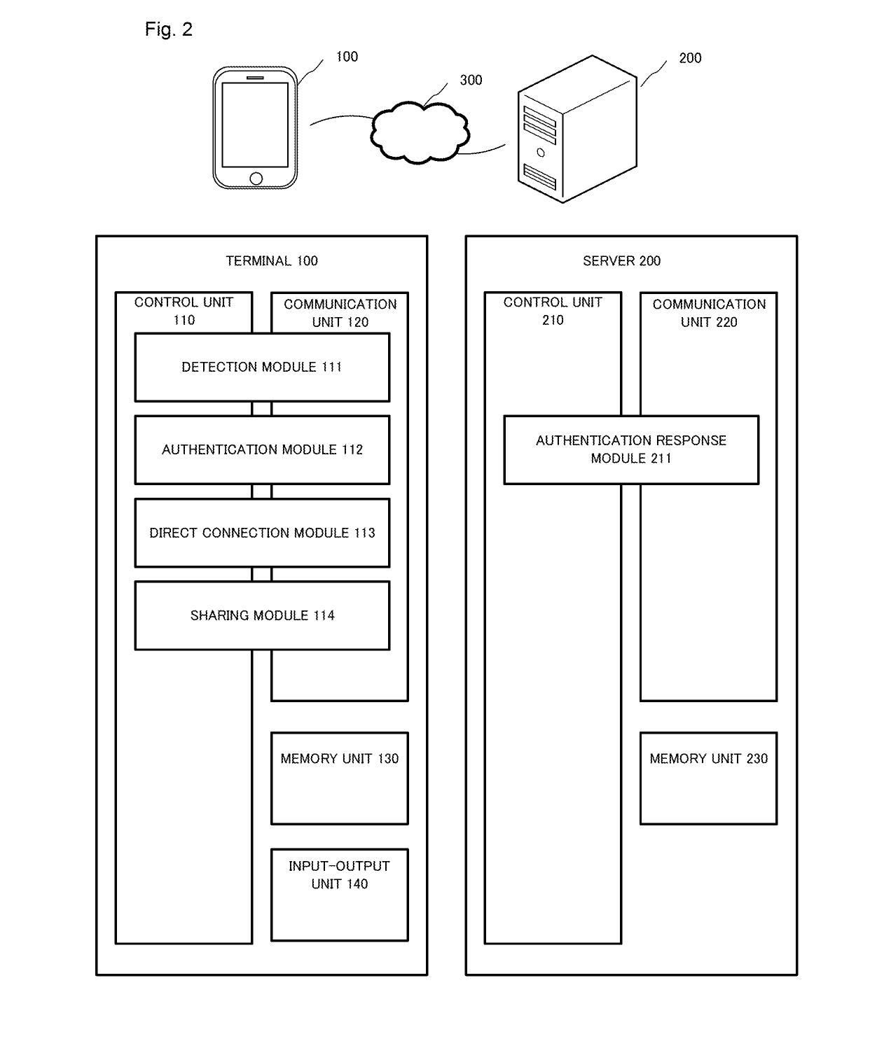

FIG. 2 is the functional block diagram of a terminal 100 and a server 200 to illustrate the relationship among the functions. The screen sharing system 1 includes a plurality of terminals 100, a server 200, and a public line network 300 (e.g. the Internet network, a third and a fourth generation networks). The source terminal 100a and the destination terminal 100b that are shown in FIG. 1 have the same functions as those of the terminal 100.

The terminal 100 includes a control unit 110, a communication unit 120, a memory unit 130, and an input-output unit 140. The control unit 110 runs a detection module 111, an authentication module 112, a direct connection module 113, and a sharing module 114 in cooperation with the communication unit 120. The server 200 includes a control unit 210, a communication unit 220, and a memory unit 230. The control unit 210 runs an authentication response module 211 in cooperation with the communication unit 220.

The terminal 100 may be a general information terminal capable of allowing a user to browses web pages and executing various applications. The terminal 100 is an information device or an electrical appliance with the functions to be described later. For example, the terminal 100 may be a general information appliance such as a mobile phone, a smart phone, a tablet PC, a notebook, or a wearable device, a complex printer, a television, and a network device such as a router or a gateway. The terminal 100 may also be a white good such as a refrigerator or a washing machine. The terminal 100 may also be an electrical appliance such as a telephone, a netbook terminal, a slate terminal, an electronic book terminal, an electronic dictionary terminal, a portable music player, and a portable content player and recorder. The smart phone shown as the terminal 100 in attached drawings is just one example.

In the terminal 100, the control unit 110 includes a central processing unit (hereinafter referred to as “CPU”), a random access memory (hereinafter referred to as “RAM”), and a read only memory (hereinafter referred to as “ROM”).

The communication unit 120 includes a Wireless Fidelity (Wi-Fi®) enabled device complying with, for example, IEEE 802.11, or a wireless device complying with the IMT-2000 standard such as the third generation mobile communication system. The communication unit may include a wired device for LAN connection.

In the terminal 100, the control unit 110 reads a predetermined program to run a detection module 111, an authentication module 112, a direct connection module 113, and a sharing module 114 in cooperation with the communication unit 120.

The user terminal 100 also includes a storage unit as the memory unit 130 such as a hard disk or a semiconductor memory to store data. The memory unit 130 can store necessary information such as temporary data to share a screen.

The input-output unit 140 has functions to perform operation and display necessary for screen sharing. The input-output unit 140 may include a liquid crystal display to achieve a touch panel function, a keyboard, a mouse, a pen tablet, a hardware button on the device, and a microphone to perform voice recognition as examples of the input unit. The input-output unit 140 may take various forms such as a liquid crystal display, a PC display, and a projector as examples of the output unit. The input-output unit 140 may include a speaker when voices are output during screen sharing. The features of the present invention are not limited in particular by an input-output method.

The server 200 may be a general server provided with the authentication function to be described later.

The server 200 includes a control unit 210 provided with CPU, RAM, ROM, etc.

The communication unit 220 includes a Wi-Fi® enabled device complying with, for example, IEEE 802.11, or a wireless device complying with the IMT-2000 standard such as the third generation mobile communication system. The communication unit may include a wired device for LAN connection.

In the server 200, the control unit 210 reads a predetermined program to run an authentication response module 211 in cooperation with the communication unit 220.

The server 200 also includes a storage unit as the memory unit 230 such as a hard disk or a semiconductor memory to store data. The memory unit 230 can store necessary information such as data for authentication.

### Screen Sharing Process

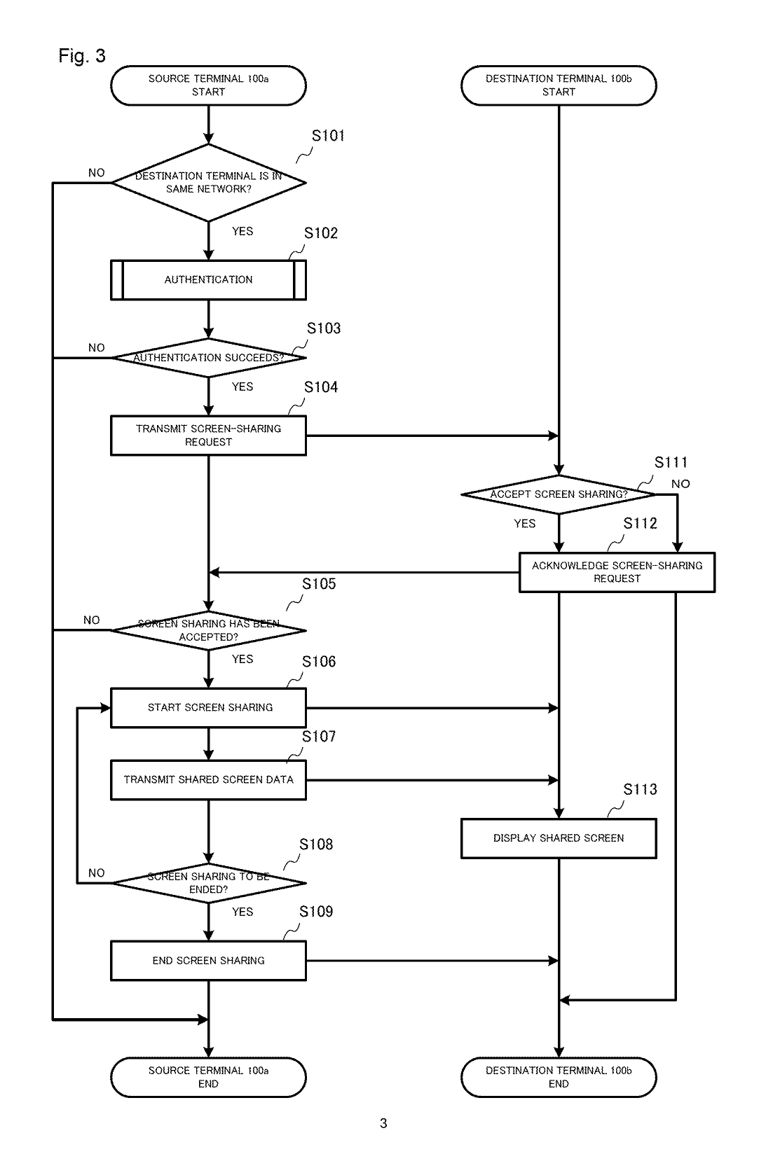

FIG. 3 is the flow chart of the screen sharing process when a destination terminal 100b displays a screen of a source terminal 100a. The tasks executed by the modules of the above-mentioned devices are explained below together with this process. As shown in FIG. 1, the terminals 100a, 100b, 100c, and 100d are in a same network. The destination terminal 100b is an example. The process may be executed by the destination terminal 100c, 100d or a plurality of destination terminals. Any one of the terminals 100b, 100c, and 100d may be a source terminal.

First, the source terminal 100a detects whether or not a destination terminal is in the same network, by running the detection module 111 (step S101). At this point, the destination terminal may be directly specified or may be selected as a candidate destination terminal from listed terminals in the same network.

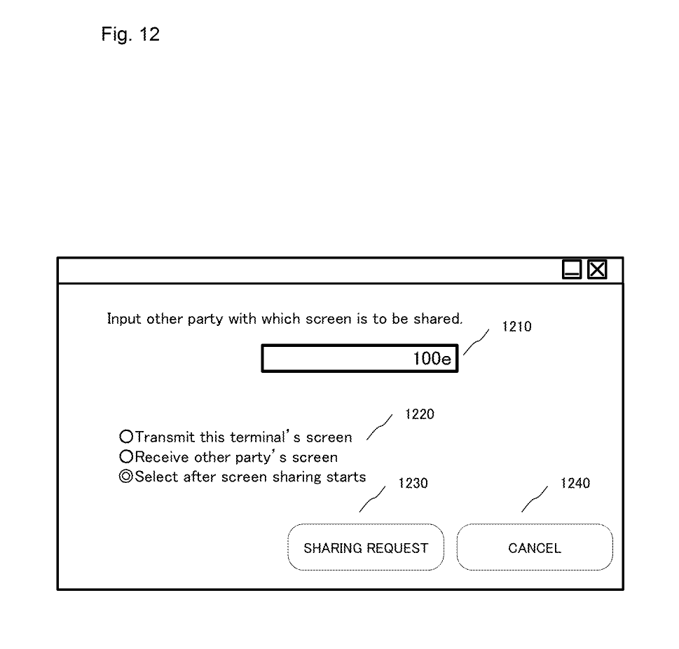

FIG. 12 shows an example of the destination input screen to directly specify a destination terminal. The other party with which a screen is to be shared is input in the entry field 1210. The input destination only has to uniquely specify the other party. For the input destination, a computer name, an IP address, a MAC address, or the like is appropriately used to conform to the system. Moreover, as the option 1220 shows, a user may have the options to transmit shared data to the destination terminal, to receive shared date from the destination terminal, and to select which screen of the source terminal or the destination terminal is to be shared after screen sharing starts. If a user presses the sharing request button 1230, the source terminal detects whether or not the destination terminal is in the same network. If a user presses the cancel button 1240, the screen sharing process is ended.

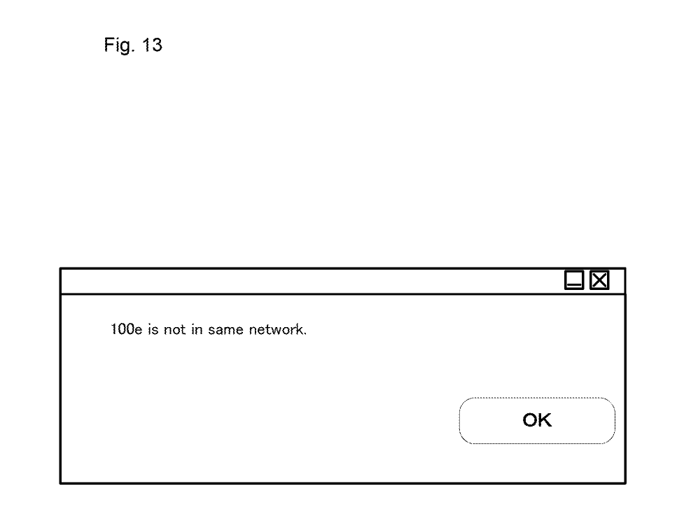

In the step S01, if not detecting that the specified destination terminal is in the same network (if the process proceeds to NO in the step S101), the source terminal ends the screen sharing process. In this case, as shown in FIG. 13, the source terminal 100a may display an error screen to show that the specified destination terminal cannot be detected in the same network.

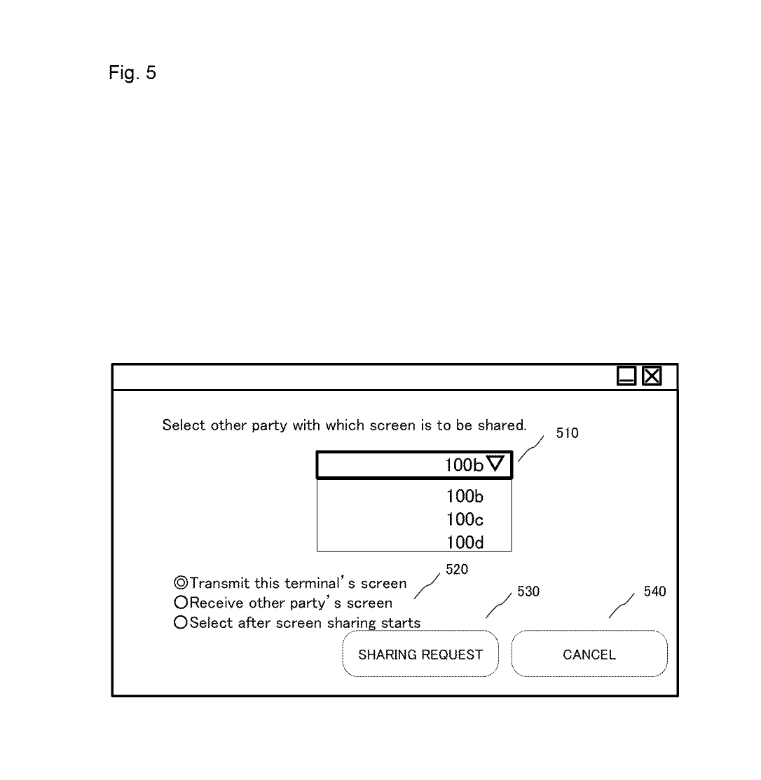

FIG. 5 is an example of the screen to select a destination terminal with which a screen is to be shared after terminals in the same network are listed. In this example, the terminal 100b is selected in the selection field 510 as the other party with which the source terminal 100a is to share a screen. Moreover, the option to transmit the screen of the source terminal 100a to the destination terminal 100b as shared screen data is selected from the options 520. In this case, since only terminals in the same network are displayed as options, the process proceeds to the next step S102 if a user presses the sharing request button 530. If a user presses the cancel button 540, the screen sharing process may be ended, or terminals in the same network may be listed again.

Then, the source terminal 100a performs the authentication process by running the authentication module 112 (step S102). Details of the authentication process are described later.

After the authentication process, the source terminal 100a judges whether or not the authentication succeeds (step S103). If the authentication succeeds, the source terminal 100a directly connects to the destination terminal 100b through P2P by running the direct connection module 113 to transmit a screen-sharing request to the destination terminal 100b (step S104). All the connections between the source terminal 100a and the destination terminal 100b are direct. If the authentication fails, the screen sharing process is ended.

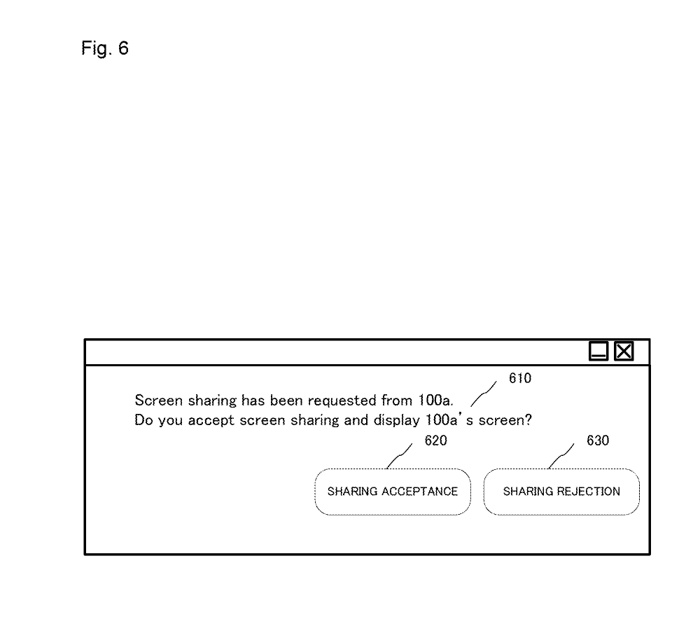

The destination terminal 100b receives the screen-sharing request from the source terminal 100a and judges whether or not to accept the screen sharing (step S111). FIG. 6 shows an example of the screen-sharing request screen displayed on the destination terminal 100b. The message 610 says that the destination terminal 100b has received a screen-sharing request from the terminal 100a and displays a screen of the terminal 100a if accepting the screen-sharing request.

If the sharing acceptance button 620 is pressed, the destination terminal 100b transmits a positive acknowledgement of the screen-sharing request (step S112). If the sharing rejection button 630 is pressed, the destination terminal 100b transmits a negative acknowledgement of the screen-sharing request (step S112).

Then, the source terminal 100a judges whether or not the destination terminal 100b has accepted the screen-sharing request (step S105). If the destination terminal 100b has accepted, the source terminal 100a notifies the destination terminal 100b of the start of screen sharing by running the sharing module 114 (step S106). If the screen-sharing request is rejected, the screen sharing process is ended.

After notifying the destination terminal 100b of the start of screen sharing, the source terminal 100a transmits and receives shared screen data by running the sharing module 114. In this embodiment, as selected as shown in FIG. 5, the screen of the source terminal 100a is transmitted to the destination terminal 100b as shared screen data (step S107).

The destination terminal 100b displays a shared screen based on the shared screen data received from the source terminal 100a (step S113). The shared screen of the source terminal 100a needs not to be enlarged to the full screen of the destination terminal 100b and can be displayed in a size and a position to conform to the system. Moreover, how often data displayed on the destination terminal 100b is updated may be determined to conform to the system of the destination terminal 100b in consideration of the interval for receiving shared screen data from the source terminal 100a.

To end the screen sharing, the destination terminal 100b may notify the source terminal 100a of the end of screen sharing. In addition, if the shared screen needs to be switched from the screen of the source terminal 100a to the screen of the destination terminal 100b during screen sharing, the destination terminal 100b may notify the source terminal 100a of the switch of shared screens and transmit shared screen data to the source terminal 100a.

The source terminal 100a judges whether or not to end the screen sharing after transmitting shared screen data (step S108). If judging to end the screen sharing, the source terminal 100a notifies the destination terminal 100b of the end of screen sharing to end the screen sharing (step S109). If judging to not end the screen sharing, the process returns to the step S106 and continues.

In a series of the steps S106 to S108, how often shared screen data is transmitted from the source terminal 100a to the destination terminal 100b may be determined in consideration of the communication speed between these terminals and the specifications thereof. In addition, if the shared screens need to be switched to those of the destination terminal 100b during screen sharing, the source terminal 100a may notify the destination terminal 100b of the switch of shared screens, receive shared screen data from the destination terminal 100b, and then display the screen of the destination terminal 100b.

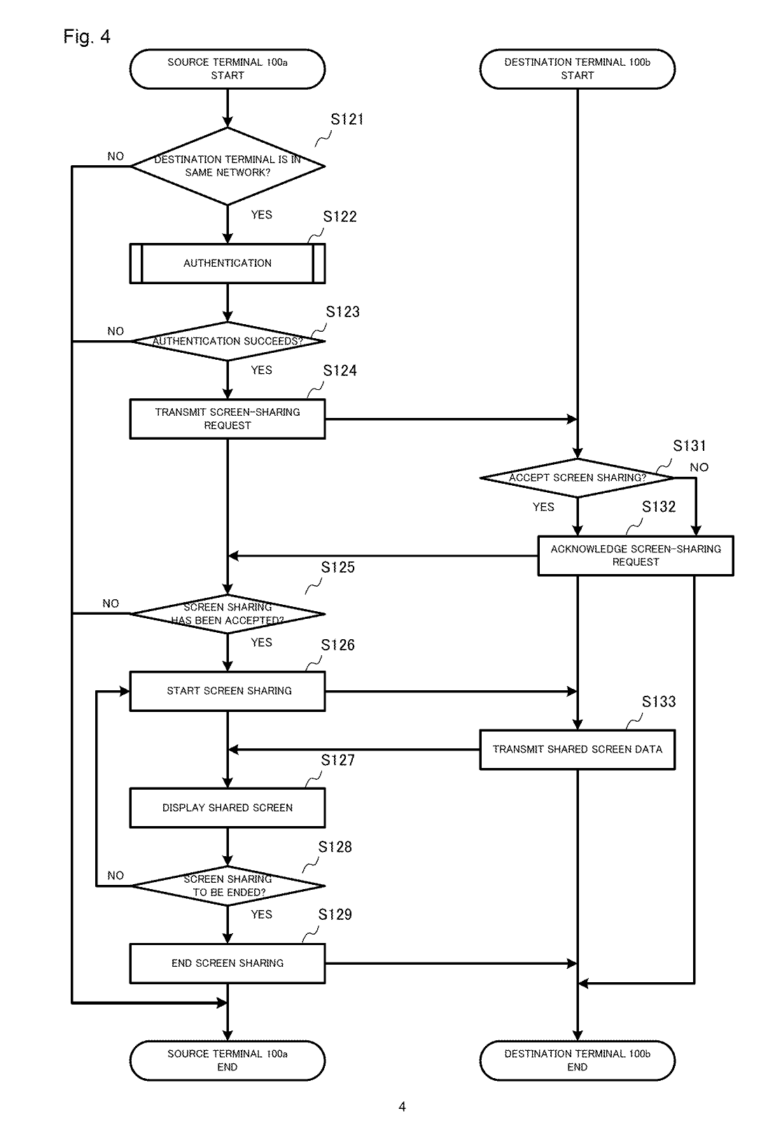

FIG. 4 is the flow chart of the screen sharing process when a source terminal 100a displays a screen of a destination terminal 100b. The difference between FIGS. 3 and 4 is mainly explained below.

First, the source terminal 100a detects whether or not a destination terminal is in the same network, with the detection module 111 (step S121). At this point, the destination terminal may be directly input or may be selected as a candidate destination terminal from listed terminals in the same network.

In the step S01, if not detecting that the specified destination terminal is in the same network (if the process proceeds to NO in the step S121), the source terminal ends the screen sharing process. In this case, the source terminal 100a may display an error screen.

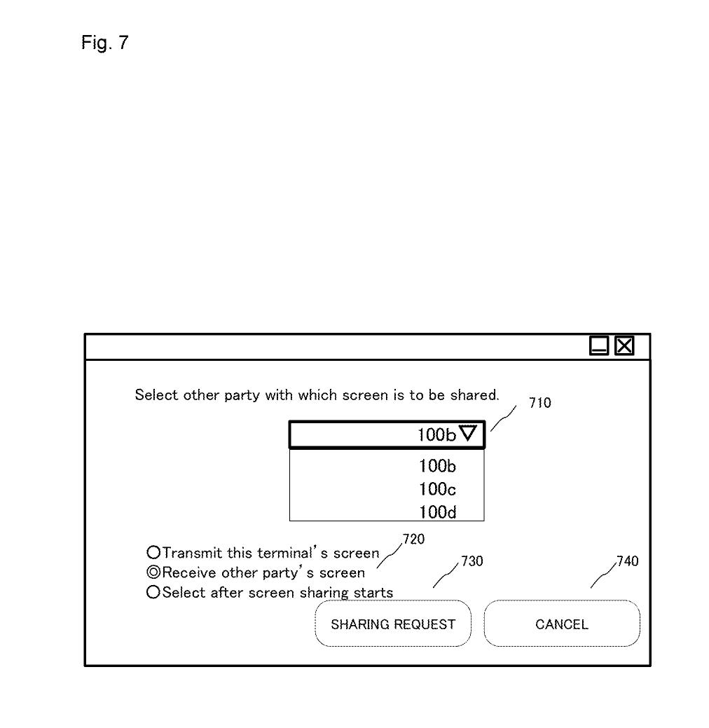

FIG. 7 is an example of the screen to select a destination terminal with which a screen is to be shared after terminals in the same network are listed. In this example, the terminal 100b is selected in the selection field 710 as the other party with which the source terminal 100a is to share a screen. Moreover, the option to receive shared screen data from the destination terminal 100b is selected from the options 720. In this case, since only terminals in the same network are displayed as options, the process proceeds to the next step S122 if a user presses the sharing request button 730. If a user presses the cancel button 740, the screen sharing process ends, or terminals in the same network may be listed again.

Then, the source terminal 100a performs the authentication process by running the authentication module 112 (step S122). Details of the authentication process are described later.

After the authentication process, the source terminal 100a judges whether or not the authentication succeeds (step S123). If the authentication succeeds, the source terminal 100a directly connects to the destination terminal 100b through P2P by running the direct connection module 113 to transmit a screen-sharing request to the destination terminal 100b (step S124). All the connections between the source terminal 100a and the destination terminal 100b are direct. If the authentication fails, the screen sharing process is ended.

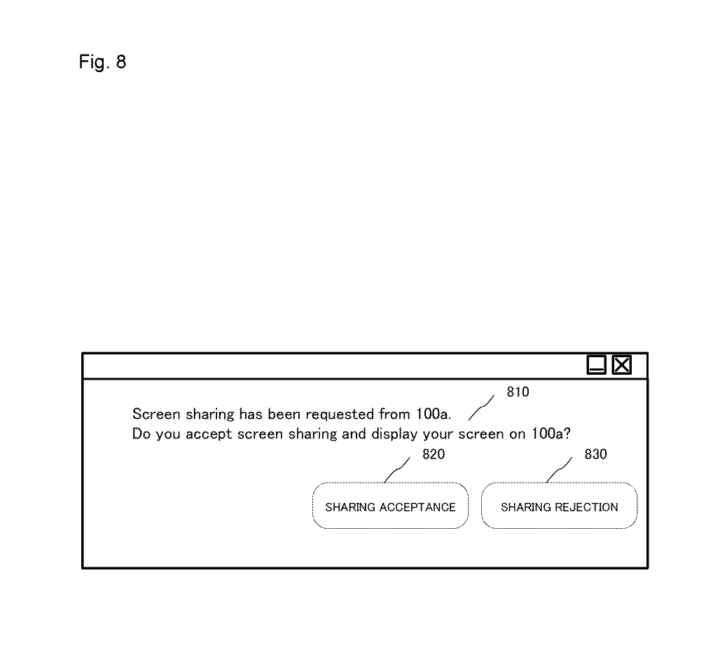

The destination terminal 100b receives the screen-sharing request from the source terminal 100a and judges whether or not to accept the screen sharing (step S131). FIG. 8 shows an example of the screen-sharing request screen displayed on the destination terminal 100b. The message 810 says that the destination terminal 100b has received a screen-sharing request from the terminal 100a and that the terminal 100a displays a screen of the terminal 100b if the destination terminal 100b accepts the screen-sharing request.

If the sharing acceptance button 820 is pressed, the destination terminal 100b transmits a positive acknowledgement of the screen-sharing request. If the sharing rejection button 830 is pressed, the destination terminal 100b transmits a negative acknowledgement of the screen-sharing request (step S132).

Then, the source terminal 100a judges whether or not the destination terminal 100b has accepted the screen-sharing request (step S125). If the destination terminal 100b has accepted, the source terminal 100a notifies the destination terminal 100b of the start of screen sharing by running the sharing module 114 (step S126). If the screen-sharing request is rejected, the screen sharing process is ended.

After notifying the destination terminal 100b of the start of screen sharing, the source terminal 100a transmits and receives shared screen data by running the sharing module 114. In this embodiment, as selected as shown in FIG. 7, the screen of the destination terminal 100b is transmitted to the source terminal 100a as shared screen data (step S133).

The source terminal 100a displays a shared screen based on the shared screen data received from the destination terminal 100b (step S127). The shared screen of the destination terminal 100b needs not to be enlarged to the full screen of the source terminal 100a and can be displayed in a size and a position to conform to the system. Moreover, how often data displayed on the source terminal 100a is updated may be determined to conform to the system of the source terminal 100a in consideration of the interval for receiving shared screen data from the destination terminal 100b.

To end the screen sharing, the destination terminal 100b may notify the source terminal 100a of the end of screen sharing. In addition, if the shared screens need to be switched to those of the source terminal 100a during screen sharing, the destination terminal 100b may notify the source terminal 100a of the switch of shared screens, receive shared screen data from the source terminal 100a, and then display a screen of the source terminal 100a.

The source terminal 100a judges whether or not to end the screen sharing after displaying shared screen (step S128). If judging to end the screen sharing, the source terminal 100a notifies the destination terminal 100b of the end of screen sharing to end the screen sharing (step S129). If judging to not end the screen sharing, the process returns to the step S126 and continues.

In a series of the steps S126 to S128, how often shared screen data is transmitted from the destination terminal 100b to the source terminal 100a may be determined in consideration of the communication speed between these terminals and the specifications thereof. In addition, if the shared screens are needed to be switched to those of the source terminal 100a during screen sharing, the source terminal 100a may notify the destination terminal 100b of the switch of shared screens and then transmit shared screen data to the destination terminal 100b, and the destination terminal 100b displays a screen of the source terminal 100a.

### Authentication Process

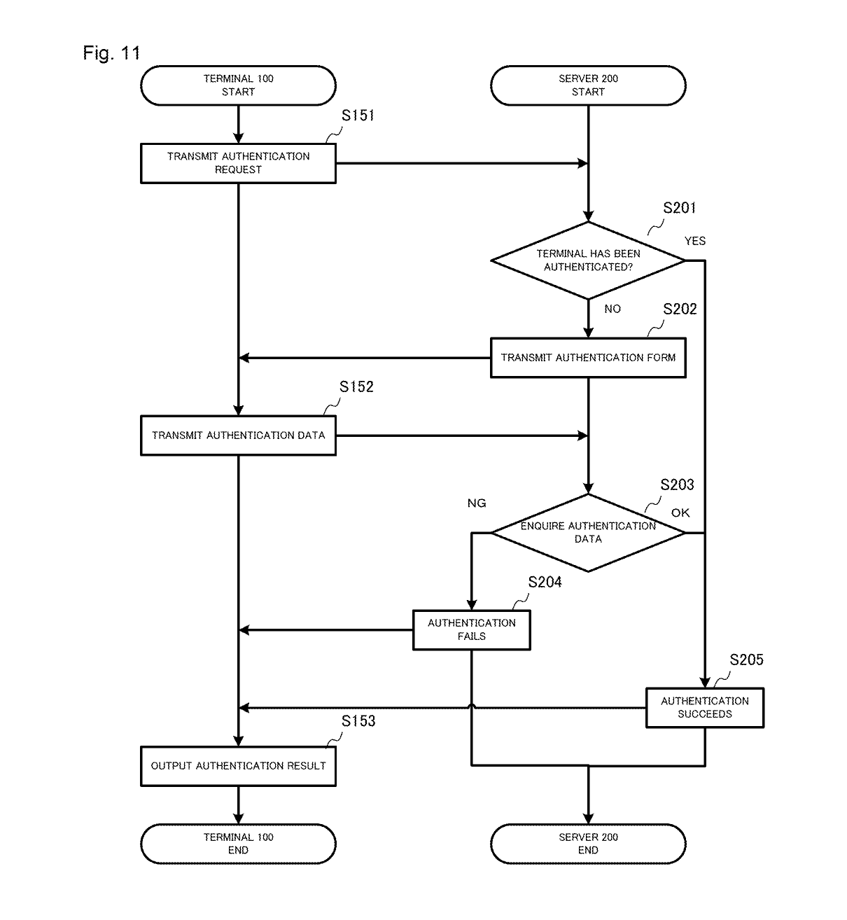

FIG. 11 is a flow chart of the authentication process executed by the terminal 100 and the server 200. The tasks executed by the modules of the above-mentioned devices are explained below together with this process. The source terminal 100a and the destination terminal 100b that are shown in FIG. 11 have the same functions as those of the terminal 100 of FIG. 2 in the authentication process. As shown in FIG. 2, the terminal 100 is connected with the server 200 through a public line network 300.

First, the terminal 100 transmit an authentication request to the server 200 (step S151).

The server 200 receives the authentication request from the terminal 100 and performs the authentication process described below by running the authentication response module 211. The server judges whether or not the terminal 100 has already been authenticated (step S201). If the terminal 100 has already been authenticated, the process proceeds to the step S205. If the terminal 100 has not been authenticated yet, the process proceeds to the step S202.

At this point, the server 200 may not judge only whether or not the terminal 100 has already been authenticated in the system for sharing a screen. For example, the authentication when the terminal 100 accesses a device such as a network printer or data in the same network may be considered as the authentication in the system for sharing a screen.

If the terminal 100 has not been authenticated yet, the server 200 transmits an authentication form to the terminal 100 (step S202). The authentication form is, for example, a request for a user ID and a password. The authentication method herein may be a general authentication method. Therefore, an authentication method appropriate for the system, which requires a user ID and a password, a one-time password, a one-time URL, a client certificate, a biological information recognition, etc., may be used.

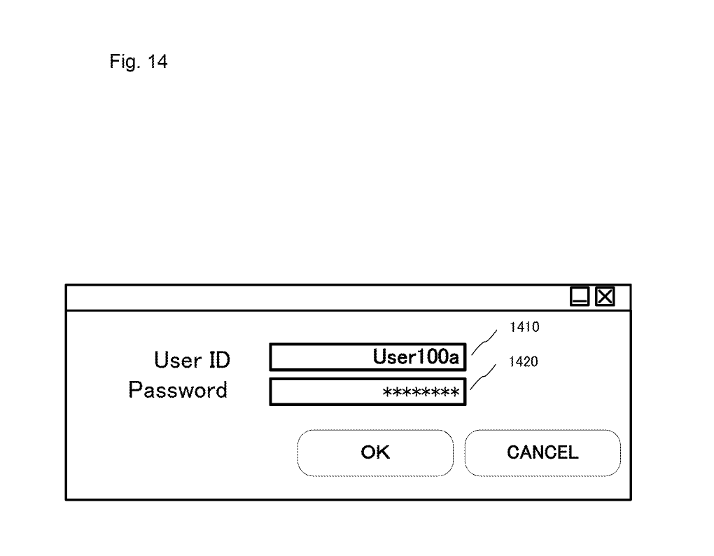

The terminal 100 receives the authentication form and transmits the corresponding authentication data to the server 200 (step S152). FIG. 14 shows an example of the screen displayed on the terminal 100 to have a user input a user ID and a password. A user input a user ID and a password to the entry fields 1410 and 1420, respectively. The authentication data is generated based on these input data. In this example, an ID and a password are input. If a user ID and a password, a one-time password, a one-time URL, a client certificate, and a biological information data are required, the corresponding authentication data are generated and transmitted.

Then, the server 200 enquires authentication data (step S203). The server 200 enquires authentication data stored in the memory unit 230, etc., to judge whether or not the authentication data received from the terminal 100 matches the stored data. This data inquiry method does not limit the features of the present invention. For the data inquiry, a general method may be used.

If the inquiry of authentication data fails, the server 200 notifies the terminal 100 of authentication failure (step 204). If the inquiry of authentication data succeeds, the server 200 notifies the terminal 100 of authentication success (step 205).

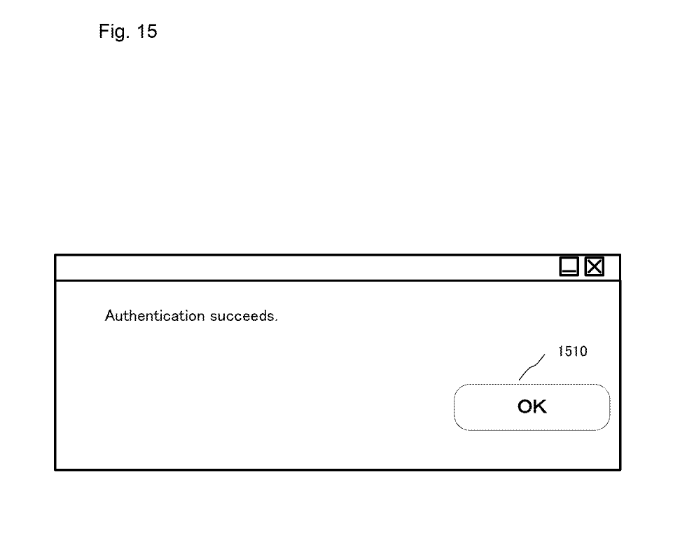

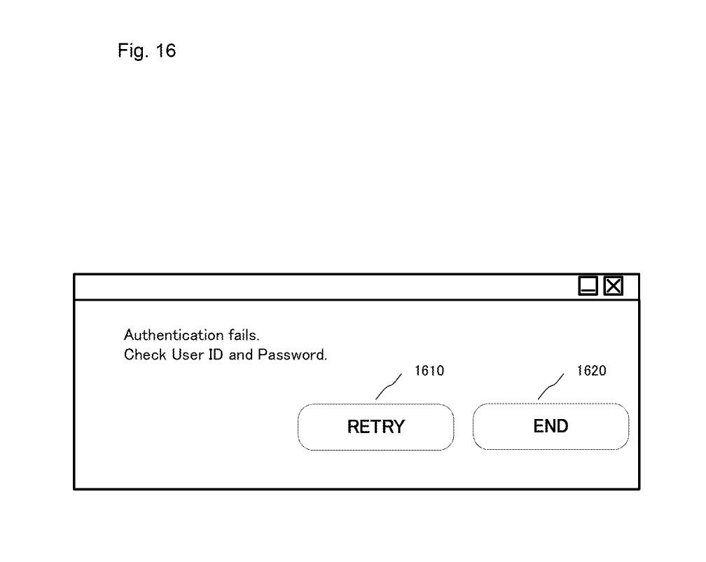

The terminal 100 outputs the authentication result to the input-output unit 140 (step S153). FIG. 15 shows an example of the dialog screen displayed on the terminal 100 if the authentication succeeds. If a user presses the OK button 1510, the authentication process is ended with authentication success. FIG. 16 shows an example of the dialog screen displayed on the terminal 100 if the authentication fails. If a user presses the retry button 1610 shown in FIG. 16, the screen shown in FIG. 14 may be displayed to have a user input a user ID and a password again. If a user presses the end button 1620, the authentication process is ended with authentication failure. The authentication result is displayed in a dialog in this example but may be audibly output.

To achieve the means and the functions that are described above, a computer (including CPU, an information processor, and various terminals) reads and executes a predetermined program. For example, the program is provided in the form recorded in a computer-readable medium such as a flexible disk, CD (e.g., CD-ROM), DVD (e.g., DVD-ROM, DVD-RAM), or a compact memory. In this case, a computer reads a program from the record medium, forwards and stores the program to and in an internal or an external storage, and executes it. The program may be previously recorded in, for example, a storage (record medium) such as a magnetic disk, an optical disk, or a magnetic optical disk and provided from the storage to a computer through a communication line.

The embodiments of the present invention are described above. However, the present invention is not limited to the above-mentioned embodiments. The effects described in the embodiments of the present invention are only the most preferable effect produced from the present invention. The effects of the present invention are not limited to those described in the embodiments of the present invention.

### REFERENCE SIGNS LIST

100 Terminal
200 Server
300 Public line network

What is claimed is:

1. A system for sharing a screen, comprising a terminal and a server, the system permitting the terminal connected with a same network to share a screen, wherein
the terminal includes:
a detection unit that detects whether or not a destination terminal is connected with the same network;
an authentication unit that authenticates the destination terminal for screen sharing if the detection unit detects that the destination terminal is connected with the same network;
a direct connection unit that directly connects to the destination terminal if the authentication unit authenticates the destination terminal; and
a sharing unit that shares a screen with the destination terminal by the direct connection.

2. The system according to claim 1, wherein the terminal is connected with the server,
the authentication unit authenticates the destination terminal for screen sharing by enquiring of the server about the authentication.

3. The system according to claim 1, wherein
the sharing unit serially transmits shared data to the destination terminal or serially receives shared data from the destination terminal.

4. A method for sharing a screen, comprising the step of permitting the terminal connected with a same network to share a screen, wherein
the terminal executes the steps of:
detecting whether or not a destination terminal is connected with the same network;
authenticating the destination terminal for screen sharing if detecting that the destination terminal is connected with the same network;
directly connecting to the destination terminal if authenticating the destination terminal; and
sharing a screen with the destination terminal by the direct connection.

5. A computer program product for use in a system for sharing a screen, including a terminal and a server, the system permitting the terminal connected with a same network to share a screen, comprising a non-transitory computer usable medium having a set of instructions physically embodied therein, the set of instructions including computer readable program code, which when executed by the system for sharing a screen causes the information processing unit to:
detect whether or not a destination terminal is connected with the same network;
authenticate the destination terminal for screen sharing if detecting that the destination terminal is connected with the same network;
directly connect to the destination terminal if authenticating the destination terminal; and
share a screen with the destination terminal by the direct connection.
